(19) United States
(12) Patent Application Publication
(10) Pub. No.: US 2021/0390672 A1
(43) Pub. Date: Dec. 16, 2021

(54) IMAGE PROCESSING DEVICE, IMAGE PROCESSING METHOD, AND IMAGE PROCESSING SYSTEM

(71) Applicant: Panasonic Intellectual Property Management Co., Ltd., Osaka (JP)

(72) Inventors: Nobutoshi FUJINAMI, Osaka (JP); Tsuyoshi HIRASHIMA, Osaka (JP); Kenji TAKITA, Osaka (JP)

(73) Assignee: Panasonic Intellectual Property Management Co., Ltd., Osaka (JP)

(21) Appl. No.: 17/230,672

(22) Filed: Apr. 14, 2021

(30) Foreign Application Priority Data
Apr. 16, 2020 (JP) 2020-073508
Jan. 26, 2021 (JP) 2021-010664

(51) Int. Cl. G06T 5/00; G06T 7/90; G06T 3/40

(52) U.S. Cl. CPC G06T 5/009; G06T 7/90; G06T 2207/10144; G06T 3/4015; G06T 2207/10024; G06T 5/002

(57) ABSTRACT

An image processing device includes: a computation unit that calculates signal values of a plurality of second colors by using signal values of a plurality of first colors obtained from an image sensor; a saturation determiner that determines whether or not at least one of the plurality of first colors is saturated by using the signal values of the plurality of first colors; and a corrector that corrects at least one signal value of the plurality of second colors and outputs a corrected signal value, when the saturation determiner determines that the at least one of the plurality of first colors is saturated.

### CROSS REFERENCE TO RELATED APPLICATIONS

The present application is based on and claims priority of Japanese Patent Application No. 2020-073508 filed on Apr. 16, 2020 and Japanese Patent Application No. 2021-010664 filed on Jan. 26, 2021.

### FIELD

The present disclosure relates to an image processing device, an image processing method, and an image processing system.

### BACKGROUND

Conventionally, a device has been disclosed that includes: a white pixel that transmits all wavelengths; a first color separation pixel having a multilayer film or a photonic crystal that cuts a wavelength region higher than a first wavelength; and a second color separation pixel having a multilayer film or a photonic crystal that cuts a wavelength region higher than a second wavelength, the second wavelength being higher than the first wavelength (see Patent Literature (PTL) 1).

### CITATION LIST

### Patent Literature

PTL 1: Japanese Unexamined Patent Application Publication No. 2008-205940

### SUMMARY

However, the device according to PTL 1 can be improved upon.

In view of this, the present disclosure provides an image processing device, an image processing method, and an image processing system capable of improving upon the above related art.

An image processing device according to one aspect of the present disclosure includes: a computation unit that calculates signal values of a plurality of second colors by using signal values of a plurality of first colors obtained from an image sensor; a saturation determiner that determines whether or not at least one of the plurality of first colors is saturated by using the signal values of the plurality of first colors; and a corrector that corrects at least one signal value of the plurality of second colors and outputs a corrected signal value, when the saturation determiner determines that the at least one of the plurality of first colors is saturated.

An image processing method according to one aspect of the present disclosure includes: calculating signal values of a plurality of second colors by using signal values of a plurality of first colors obtained from an image sensor; determining whether or not at least one of the plurality of first colors is saturated by using the signal values of the plurality of first colors; and correcting at least one signal value of the plurality of second colors and outputting a corrected signal value, when the at least one of the plurality of first colors is determined to be saturated.

An image processing system according to one aspect of the present disclosure includes: a plurality of image processing devices, each being the aforementioned image processing device. The plurality of image processing devices process a plurality of exposure images captured at mutually different exposure times and including signal values of the plurality of first colors.

The image processing device, the image processing method, and the image processing system according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram of an image processing device according to Embodiment 1.

FIG. 2 is a diagram for illustrating correction performed by a corrector of the image processing device in FIG. 1, and illustrating when a mean value of signal values of one or more colors that are not to be corrected is used as a corrected signal value of a color to be corrected.

FIG. 3 is a diagram for illustrating correction performed by the corrector of the image processing device in FIG. 1, and illustrating when a signal value of the color to be corrected is used as a corrected signal value the color to be corrected.

FIG. 4 is a flowchart illustrating an example of an operation of a saturation determiner of the image processing device in FIG. 1.

FIG. 5 is a flowchart illustrating an example of an operation of the corrector of the image processing device in FIG. 1.

FIG. 6 is a block diagram of an image processing device according to Embodiment 2.

FIG. 7 is a diagram for illustrating smoothing in a spatial direction performed by a smoothing filter of the image processing device in FIG. 6.

FIG. 8 is a diagram for illustrating smoothing in a time direction performed by a smoothing filter of the image processing device in FIG. 6.

FIG. 9 is a block diagram of an image processing system according to Embodiment 3.

FIG. 10 is a block diagram of an image processing system according to Embodiment 4.

FIG. 11 is a diagram for illustrating an example of an interpolation filter.

### DESCRIPTION OF EMBODIMENTS

The following specifically describes embodiments with reference to the drawings.

Note that each of the embodiments described below shows a general or specific example. The numerical values, shapes, materials, structural components, arrangement and connection of the structural components, steps and the order of the steps, etc. mentioned in the following embodiments are mere examples and not intended to limit the present disclosure. Among the structural elements in the following embodiments, structural components not recited in any one of the independent claims representing broadest concepts are described as optional structural components. In addition, each diagram is a schematic diagram and is not necessarily a precise illustration. Moreover, in each figure, structural components that are essentially the same share like reference signs.

### Embodiment 1

Image processing device 10 according to Embodiment 1 will be described.

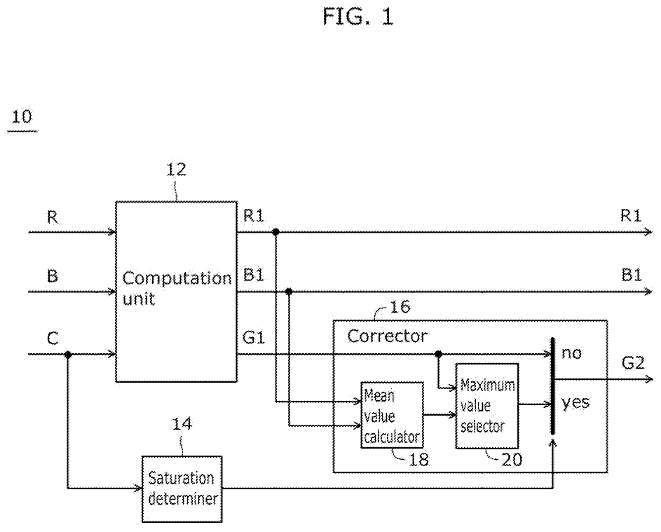

FIG. 1 is a block diagram of image processing device 10 according to Embodiment 1. A functional configuration of image processing device 10 will be described with reference to FIG. 1.

As illustrated in FIG. 1, image processing device 10 includes computation unit 12, saturation determiner 14, and corrector 16. For example, computation unit 12, saturation determiner 14, and corrector 16 are implemented by circuits or the like.

Computation unit 12 calculates signal values of second colors by using signal values of first colors obtained by an image sensor (not illustrated). The signal values are values of components expressing a color space, and are luminance and chrominance, for example. Furthermore, the color space is, for example, an RGB color space and a YUV color space.

The image sensor includes pixels (not illustrated) that are arranged in an array. Each of the pixels outputs a signal value corresponding to an amount of received light. In Embodiment 1, the pixels include red pixels, blue pixels, and white pixels. Each of the red pixels receives light that has passed through a filter that transmits light in a red wavelength region, and outputs a signal value corresponding to an amount of received light. Each of the blue pixels receives light that has passed through a filter that transmits light in a blue wavelength region, and outputs a signal value corresponding to an amount of received light. Each of the white pixels receives light that has passed through a filter that transmits light in all wavelength regions, and outputs a signal value corresponding to an amount of received light. Note that each of the white pixels may receive light that has not passed through a filter, and outputs a signal value corresponding to an amount of received light. For example, the red wavelength region ranges from 620 nm to 750 nm, the blue wavelength region ranges from 450 nm to 495 nm, and all wavelength regions are all of the wavelength regions of visible light.

Computation unit 12 obtains a signal value of red output from a red pixel of the image sensor and a blue signal value output from a blue pixel of the image sensor. Computation unit 12 also obtains a signal value output from a white pixel of the image sensor. The signal value output from the white pixel is of a color of light that has passed through a filter that transmits light in all wavelength regions and has been received by the image sensor. Accordingly, in Embodiment 1, the first colors are red, blue, and a color of light that has passed through a filter that transmits light of all wavelength regions and received by the image sensor. Note that the color of light that has passed through a filter that transmits light in all wavelength regions and received by the image sensor may be referred to as “clear” in the following description.

Computation unit 12 uses the signal value of red, the signal value of blue, and the signal value of clear obtained from the image sensor to calculate a signal value of red, a signal value of blue, and a signal value of green. As such, in Embodiment 1, the second colors are red, blue, and green, and computation unit 12 calculates a signal value of a color that is none of the first colors by using the signal values of the first colors obtained from the image sensor. Note that, among the first colors, a signal value of red may be denoted as R, a signal value of blue may be denoted as B, and a signal value of clear may be denoted as C in the following description. Furthermore, among the second colors, a signal value of red may be denoted as R1, a signal value of blue may be denoted as B1, and a signal value of green may be denoted as G1 in the following description.

Computation unit 12 uses R, B, and C to calculate R1, B1, and G1 by the following expression.

$$( \begin{matrix}R 1 \\ G 1 \\ B 1\end{matrix} ) = ( \begin{matrix}a & b & c \\ d & e & f \\ g & h & i\end{matrix} ) ( \begin{matrix}R \\ C \\ B\end{matrix} ) + ( \begin{matrix}b 0 \\ b 1 \\ b 2\end{matrix} ) \qquad [ Math . 1 ]$$

As in the expression above, computation unit 12 performs matrix operation by using R, B, and C. In the above expression, a, b, c, d, e, f, g, h, i, b0, b1, and b2 are constants, and these constants are set to values such that R=R1 and B=B1, for example.

Saturation determiner 14 determines whether or not at least one of the first colors is saturated by using signal values of the first colors output from the image sensor and input to computation unit 12. In Embodiment 1, saturation determiner 14 determines whether or not clear is saturated by using a signal value of clear. More specifically, saturation determiner 14 determines whether or not the signal value of clear is greater than or equal to a predetermined threshold. Saturation determiner 14 determines that clear is saturated when the signal value of clear is greater than or equal to the predetermined threshold, and determines that clear is not saturated when the signal value of clear is not greater than or equal to the predetermined threshold. For example, when the signal value of clear is an 8-bit value, the predetermined threshold is set to 255. In this case, saturation determiner 14 determines whether or not the signal value of clear is greater than or equal to 255. Saturation determiner 14 determines that clear is saturated when the signal value of clear is greater than or equal to 255, and determines that clear is not saturated when the signal value of clear is not greater than or equal to 255.

When saturation determiner 14 determines that at least one of the first colors is saturated, corrector 16 corrects at least one signal value of the second colors that is calculated by computation unit 12, and outputs a corrected signal value. More specifically, corrector 16 corrects a signal value of a color that is one of the second colors and none of the first colors and that is to be calculated by using a signal value of the saturated color. In Embodiment 1, when saturation determiner 14 determines that clear is saturated, corrector 16 corrects a signal value of green among the second colors and outputs a corrected signal value of green. As described above, the color to be corrected among the second colors in Embodiment 1 is green. Note that the corrected signal value of green among the second colors may be denoted as G2 in the following description.

Corrector 16 includes mean value calculator 18 and maximum value selector 20.

Mean value calculator 18 calculates a mean value of signal values of one or more colors that are not to be corrected among the second colors. In Embodiment 1, one or more colors that are not to be corrected among the second colors are red and blue. Mean value calculator 18 calculates a mean value of a signal value of red and a signal value of blue by using a signal value of red and a signal value of blue among the second colors.

Maximum value selector 20 compares a signal value of a color to be corrected among the second colors with a mean value of signal values of one or more colors that are not to be corrected among the second colors, i.e., a mean value calculated by mean value calculator 18. Maximum value selector 20 selects either the signal value of the color to be corrected or the mean value, whichever is greater. In Embodiment 1, maximum value selector 20 compares a signal value of green among the second colors with a mean value of a signal value of red and a signal value of blue among the second colors, and selects either the signal value of green or the mean value, whichever is greater.

When saturation determiner 14 determines that clear is saturated (see yes in FIG. 1), corrector 16 outputs the value selected by maximum value selector 20 as G2.

On the other hand, when saturation determiner 14 determines that clear is not saturated (see no in FIG. 1), corrector 16 outputs G1 as G2.

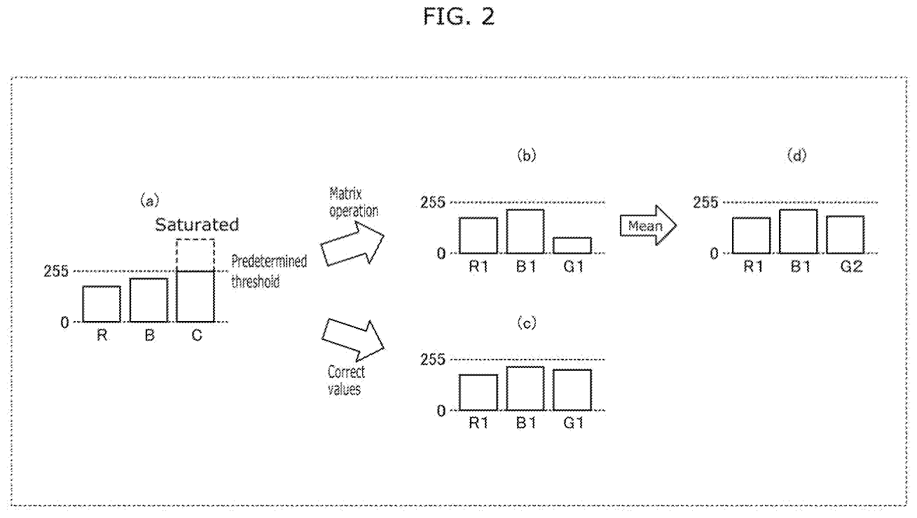

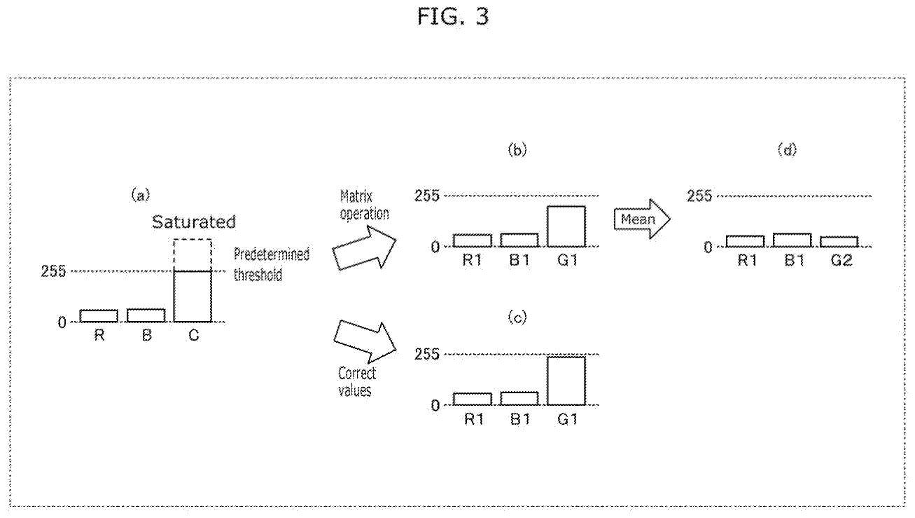

FIG. 2 is a diagram for illustrating correction performed by corrector 16 of image processing device 10 in FIG. 1 and illustrating when a mean value of signal values of one or more colors that are not to be corrected is used as a corrected signal value of a color to be corrected. FIG. 3 is a diagram for illustrating correction performed by corrector 16 of image processing device 10 in FIG. 1 and illustrating when a signal value of a color to be corrected is used as a corrected signal value the color to be corrected. Correction performed by corrector 16 will be described with reference to FIGS. 2 and 3.

For example, when clear is saturated as illustrated in (a) in FIG. 2, R1, B1, and G1 calculated by computation unit 12 have values as indicated in (b) in FIG. 2. However, R1, B1, and G1 should be values as indicated in (c) in FIG. 2. As in this example, when clear is saturated as illustrated in (a) in FIG. 2, G1 calculated by computation unit 12 is different from G1 that should be calculated. This may result in that even though an actual color is a whitish color, the whitish color is shown as if it is colored in magenta in an image.

In view of the above, as illustrated in (d) in FIG. 2, corrector 16 outputs a mean value of R1 and B1 as G2. The figure shows that G2 is a value closer to a correct G1 (see (c) in FIG. 2) than the G1 (see (b) in FIG. 2) calculated by computation unit 12. Therefore, an image having colors closer to actual colors can be produced.

Moreover, for example, as illustrated in (a) in FIG. 3, when clear is saturated in a state that R and B are less than R and B in the example illustrated in (a) in FIG. 2, R1, B1, and G1 calculated by computation unit 12 have values as indicated in (b) in FIG. 3. In this case, R1, B1, and G1 should be values as indicated in (c) in FIG. 3. Also in this example, when clear is saturated as illustrated in (a) in FIG. 3, G1 calculated by computation unit 12 is different from G1 that should be calculated.

Here, as illustrated in (d) in FIG. 3, when a mean value of R1 and B1 is output as G2 in the same manner as in the example described above, G2 has a value less than G1 (see (b) in FIG. 3) calculated by computation unit 12, and the value is farther from the correct G1 (see (c) in FIG. 3) than the calculated G1. As in this example, when the mean value of R1 and B1 is output as G2, G2 may be a value farther from the correct G1 (see (c) in FIG. 3) than G1 (see (b) in FIG. 3) calculated by computation unit 12.

In view of the above, when a mean value of R1 and B1 is greater than G1 calculated by computation unit 12, corrector 16 outputs the mean value as G2. On the other hand, when G1 calculated by computation unit 12 is greater than the mean value of R1 and B1, corrector 16 outputs the G1 as G2.

The configuration of image processing device 10 according to the present embodiment has been described above.

Next, an operation of image processing device 10 according to the present embodiment will be described.

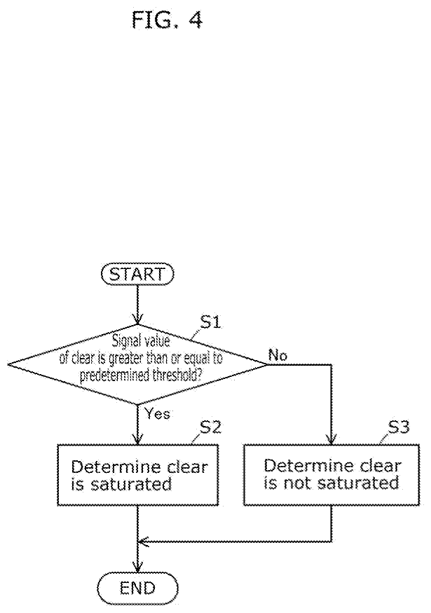

FIG. 4 is a flowchart illustrating an example of an operation of saturation determiner 14 of image processing device 10. An example of the operation of saturation determiner 14 will be described with reference to FIG. 4.

As illustrated in FIG. 4, first, saturation determiner 14 determines whether or not a signal value of clear among the first colors is greater than or equal to a predetermined threshold (step S1). The predetermined threshold is set in advance, and stored in, for example, memory (not illustrated). As described above, for example, when the signal value of clear is an 8-bit value, the predetermined threshold is set to 255. In this case, saturation determiner 14 determines whether or not the signal value of clear is greater than or equal to 255.

When the signal value of clear among the first colors is greater than or equal to the predetermined threshold (Yes in step S1), saturation determiner 14 determines that clear is saturated (step S2). For example, when the predetermined threshold is set to 255, saturation determiner 14 determines that clear is saturated if the signal value of clear is greater than or equal to 255.

On the other hand, when the signal value of clear is not greater than or equal to the predetermined threshold (No in step S1), saturation determiner 14 determines that clear is not saturated (step S3). For example, when the predetermined threshold is set to 255, saturation determiner 14 determines that clear is not saturated if the signal value of clear is not greater than or equal to 255.

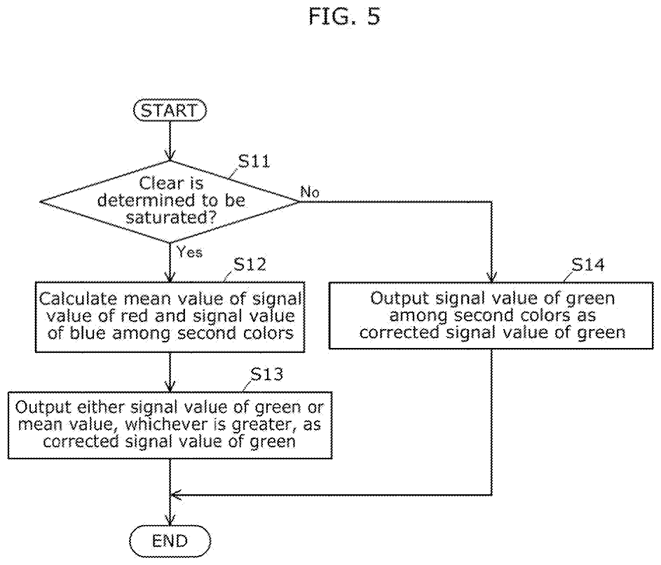

FIG. 5 is a flowchart illustrating an example of an operation of corrector 16 of image processing device 10. An example of an operation of corrector 16 will be described with reference to FIG. 5.

As illustrated in FIG. 5, first, corrector 16 determines whether or not clear is determined to be saturated (step S11). More specifically, corrector 16 determines whether or not clear is determined to be saturated by saturation determiner 14.

When clear is determined to be saturated by saturation determiner 14 (Yes in step S11), corrector 16 calculates a mean value of a signal value of red and a signal value of blue among the second colors (step S12). For example, when the signal value of red and the signal value of blue are 8-bit values and the signal value of red is 100 and the signal value of blue is 150, corrector 16 calculates the mean value as 125.

When corrector 16 calculates the mean value of the signal value of red and the signal value of blue among the second colors, either a signal value of green among the second colors or the mean value, whichever is greater, is output as a corrected signal value of green (step S13).

When clear is determined to be not saturated by saturation determiner 14 (No in step S11), corrector 16 outputs the signal value of green among the second colors as a corrected signal value of green (step S14).

Image processing device 10 according to the present embodiment has been described above.

As described above, image processing device 10 according to the present embodiment includes: computation unit 12 that calculates signal values of a plurality of second colors by using signal values of a plurality of first colors obtained from an image sensor; saturation determiner 14 that determines whether or not at least one of the plurality of first colors is saturated by using the signal values of the plurality of first colors; and corrector 16 that corrects at least one signal value of the plurality of second colors and outputs a corrected signal value, when saturation determiner 14 determines that the at least one of the plurality of first colors is saturated.

With this, when at least one of the first colors is saturated and at least one signal value of the second colors is different from a value that should be calculated, the at least one signal value can be corrected and output. Therefore, this can suppress that a color of an image becomes a color different from an actual color, which results from a signal value of the second colors being different from a value that should be calculated, thereby suppressing deterioration in quality of an image.

Moreover, in image processing device 10 according to the present embodiment, corrector 16 compares a signal value of a color to be corrected among the plurality of second colors with a mean value of signal values of one or more colors that are not to be corrected among the plurality of second colors, and outputs either the signal value of the color to be corrected or the mean value, whichever is greater, as a corrected signal value of the color to be corrected among the plurality of second colors.

When the mean value of signal values of one or more colors that are not to be corrected is greater than the signal value of the color to be corrected, the signal value that should be calculated of the color to be corrected is likely to be a value close to the mean value. Therefore, outputting the mean value as a corrected signal value of the color to be corrected achieves making a color of an image more closely resemble an actual color.

On the other hand, when the signal value of the color to be corrected is greater than the mean value of signal values of the one or more colors that are not to be corrected, the signal value that should be calculated of the color to be corrected is likely to be a value close to the signal value of the color to be corrected. Therefore, outputting the signal value of the color to be corrected as a corrected signal value of the color to be corrected achieves making a color of an image more closely resemble an actual color.

This can suppress that a color of an image becomes a color different from an actual color, and further suppress deterioration in quality of an image.

Moreover, corrector 16 outputs a mean value of signal values of one or more colors that are not to be corrected among the plurality of second colors, as a corrected signal value of a color to be corrected among the plurality of second colors.

This makes it easier to suppress that a portion that actually have a whitish color is colored in a different color, and further suppress deterioration in quality of an image.

Moreover, in image processing device 10 according to the present embodiment, the plurality of first colors include clear.

With this, a large amount of light can be taken in, and thus this can suppress deterioration in quality of an image captured at night, for example.

Moreover, in image processing device 10 according to the present embodiment, saturation determiner 14 determines whether or not clear that is one of the plurality of first colors is saturated.

With this, whether or not at least one of the first colors is saturated can be easily determined because clear is more easily saturated than other colors.

Moreover, in image processing device 10 according to the present embodiment, corrector 16 corrects a signal value of a color that is one of the plurality of second colors and none of the plurality of first colors.

The signal value of a color that is one of the second colors and none of the first colors may be calculated by using a signal value of a saturated color among the first colors. In this case, a signal value of a color that is none of the first colors is likely to be a value different from a value that should be calculated. Therefore, correcting a signal value of a color that is none of the first colors makes it easier to approximate the signal value to a value that should be calculated, and further suppress deterioration in quality of an image.

Moreover, in image processing device 10 according to the present embodiment, the plurality of first colors are red, blue, and clear, and the plurality of second colors are red, blue, and green. Among the plurality of second colors, corrector 16 corrects a signal value of green and calculates the mean value by using a signal value of red and a signal value of blue.

With this, green among the plurality of second colors can be calculated by using signal values of red, blue, and clear. Moreover, when clear is saturated, the signal value of green can be corrected by using the mean value of the signal value of red and the signal value of blue, and deterioration in quality of an image can be further suppressed.

### Embodiment 2

Next, image processing device 10a according to Embodiment 2 will be described.

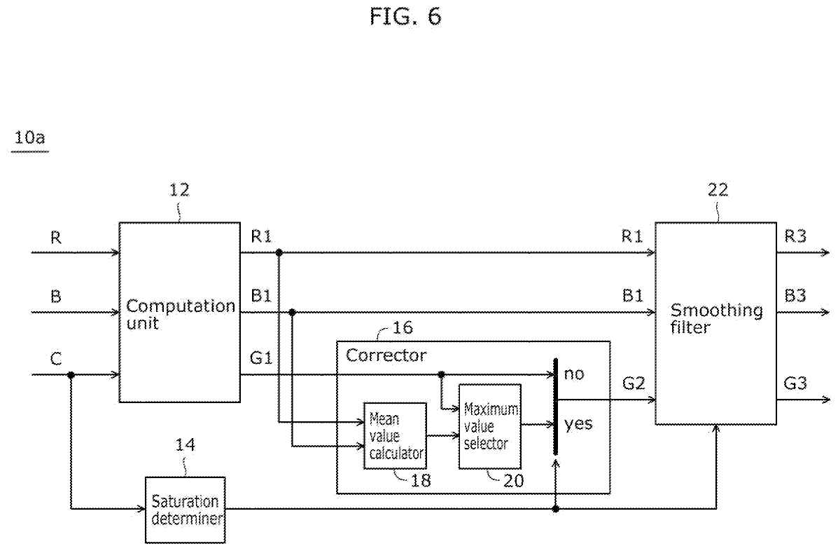

FIG. 6 is a block diagram of image processing device 10a according to Embodiment 2. Image processing device 10a differs from image processing device 10 mainly in that image processing device 10a further includes smoothing filter 22. The following description mainly describes differences of image processing device 10a from image processing device 10.

As illustrated in FIG. 6, image processing device 10a further includes smoothing filter 22. When saturation determiner 14 determines that at least one of the first colors is saturated, smoothing filter 22 performs smoothing on a corrected value of green output by corrector 16 in at least one of a spatial direction or a time direction. Moreover, smoothing filter 22 performs smoothing also on a signal value of red and a signal value of blue that are calculated by computation unit 12 in at least one of the spatial direction or the time direction. Smoothing filter 22 outputs a smoothed signal value of red, a smoothed signal value of blue, and a smoothed signal value of green. A smoothed signal value of red may be denoted as R3, a smoothed signal value of blue may be denoted as B3, and a smoothed signal value of green may be denoted as G3 in the following description.

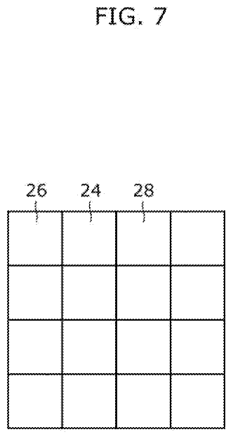

FIG. 7 is a diagram for illustrating smoothing in a spatial direction performed by smoothing filter 22 of image processing device 10a in FIG. 6. As illustrated in FIG. 7, for example, when pixels of a display are arranged in an array, computation unit 12 obtains R, B, and C and calculates R1, B1, and G1 for each of the pixels. Saturation determiner 14 determines whether or not clear is saturated for each of the pixels. Corrector 16 corrects G1 and outputs G2 for each of the pixels.

For example, when saturation determiner 14 determines that clear is saturated in pixel 24 among the pixels, smoothing filter 22 performs smoothing on R1, B1, and G2 for pixel 24 in a spatial direction. More specifically, for example, smoothing filter 22 refers to R1, B1, and G2 for pixel 26 that is adjacent to pixel 24; refers to R1, B1, and G2 for pixel 28 that is adjacent to pixel 24; and performs smoothing on R1, B1, and G2 and outputs R3, B3, and G3 for pixel 24. In this manner, smoothing filter 22 performs smoothing on R1, B1 and G2 in the spatial direction.

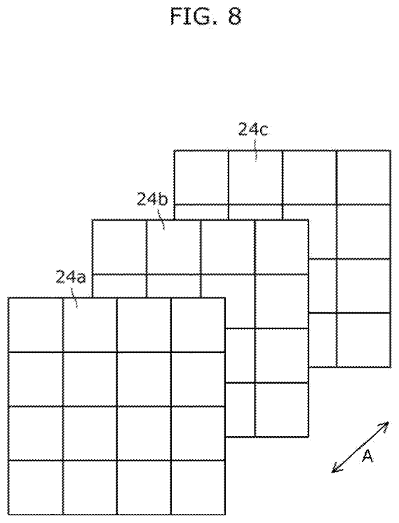

FIG. 8 is a diagram for illustrating smoothing in a time direction performed by smoothing filter 22 of image processing device 10a in FIG. 6. As illustrated in FIG. 8, for example, when saturation determiner 14 determines that clear is saturated for pixel 24b among the pixels, smoothing filter 22 performs smoothing on R1, B1, and G2 for pixel 24b in a time direction (see arrow A in FIG. 8). More specifically, for example, smoothing filter 22 refers to R1, B1, and G2 for pixel 24a that is prior to pixel 24b in the time direction; refers to R1, B1, and G2 for pixel 24c that is posterior to pixel 24b in the time direction; and performs smoothing on R1, B1, and G2 and outputs R3, B3, and G3 for pixel 24b.

Image processing device 10a according to the present embodiment has been described above.

As described above, image processing device 10a according to the present embodiment includes smoothing filter 22 that performs smoothing on a corrected signal value output by corrector 16 in at least one of a spatial direction or a time direction, when saturation determiner 14 determines that at least one of the plurality of first colors is saturated.

With this, when saturation determiner 14 determines that at least one of the first colors is saturated, smoothing filter 22 performs smoothing on a corrected signal value. Therefore, this can suppress deterioration in quality of an image.

### Embodiment 3

Next, image processing system 100 according to Embodiment 3 will be described.

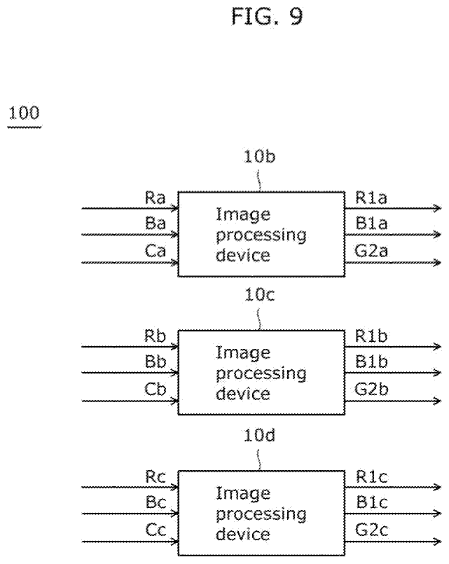

FIG. 9 is a block diagram of image processing system 100 according to Embodiment 3. As illustrated in FIG. 9, image processing system 100 includes image processing devices 10b to 10d. Image processing devices 10b to 10d each have the same configuration as the aforementioned image processing device 10. In other words, image processing system 100 includes a plurality of image processing devices 10.

Image processing devices 10b to 10d are arranged in parallel to each other, and process exposure images captured at mutually different exposure times. The exposure images include signal values of the first colors. As described above, image processing devices 10b to 10d each have the same configuration of image processing device 10, and thus detailed description of image processing devices 10b to 10d is omitted by referring to the aforementioned description of image processing device 10.

Image processing device 10b processes a first exposure image captured at a first exposure time among the exposure images. More specifically, image processing device 10b obtains signal values of the first colors that are included in the first exposure image, and processes the signal values of the first colors to process the first exposure image. The signal values of the first colors are a signal value of red (see Ra in FIG. 9), a signal value of blue (see Ba in FIG. 9), and a signal value of clear (see Ca in FIG. 9). Image processing device 10b performs processing in the same manner as image processing device 10 described in Embodiment 1 by using the signal values of the first colors, and outputs a signal value of red (see R1a in FIG. 9), a signal value of blue (see B1a in FIG. 9), and a corrected signal value of green (see G2a in FIG. 9) among the second colors. In this way, image processing device 10b processes the first exposure image by processing signal values of the first colors included in the first exposure image.

Image processing device 10c processes a second exposure image captured at a second exposure time among the exposure images. More specifically, image processing device 10c obtains signal values of the first colors that are included in the second exposure image, and processes the signal values of the first colors to process the second exposure image. The signal values of the first colors are a signal value of red (see Rb in FIG. 9), a signal value of blue (see Bb in FIG. 9), and a signal value of clear (see Cb in FIG. 9). Image processing device 10c performs processing in the same manner as image processing device 10 described in Embodiment 1 by using signal values of the first colors, and outputs a signal value of red (see R1b in FIG. 9), a signal value of blue (see B1b in FIG. 9), and a corrected signal value of green (see G2b in FIG. 9) among the second colors. In this way, image processing device 10c processes the second exposure image by processing signal values of the first colors included in the second exposure image. For example, the second exposure time is longer than the first exposure time.

Image processing device 10d processes a third exposure image captured at a third exposure time among the exposure images. More specifically, image processing device 10d obtains signal values of the first colors that are included in the third exposure image, and processes signal values of the first colors to process the third exposure image. The signal values of the first colors are a signal value of red (see Rc in FIG. 9), a signal value of blue (see Bc in FIG. 9), and a signal value of clear (see Cc in FIG. 9). Image processing device 10d performs processing in the same manner as image processing device 10 described in Embodiment 1 by using signal values of the first colors, and outputs a signal value of red (see R1c in FIG. 9), a signal value of blue (see B1c in FIG. 9), and a corrected signal value of green (see G2c in FIG. 9) of the second colors. In this way, image processing device 10d processes the third exposure image by processing signal values of the first colors included in the third exposure image. For example, the third exposure time is longer than the first exposure time and the second time.

Note that an example in which three image processing devices are used has been described in Embodiment 3, but the present disclosure is not limited to this configuration. For example, two image processing devices may be used, or four or more image processing devices may be used.

Moreover, an example in which image processing system 100 includes a plurality of image processing devices 10 has been described in Embodiment 3, but the present disclosure is not limited to this configuration. For example, image processing system may include a plurality of image processing devices 10a.

Image processing system 100 according to the present embodiment has been described above.

As described above, image processing system 100 according to the present embodiment includes a plurality of image processing devices 10, and the plurality of image processing devices 10 process a plurality of exposure images captured at mutually different exposure times and including signal values of the plurality of first colors.

With this, when images are captured at mutually different exposure times, image processing devices 10 can process the exposure images that have been captured.

### Embodiment 4

Next, image processing device 10e according to Embodiment 4 will be described.

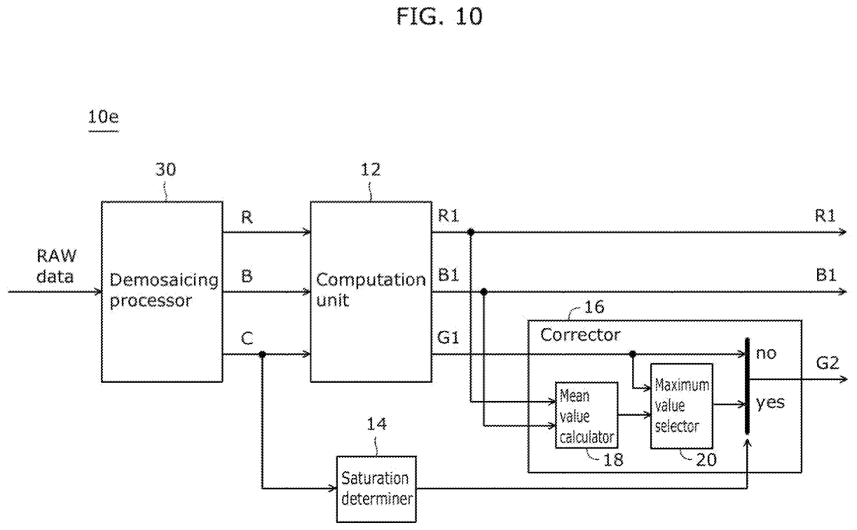

FIG. 10 is a block diagram of image processing device 10e according to Embodiment 4. Image processing device 10e differs from image processing device 10 mainly in that image processing device 10e further includes demosaicing processor 30. The following description mainly describes differences of image processing device 10e from image processing device 10.

As illustrated in FIG. 10, image processing device 10e further includes demosaicing processor 30 upstream of computation unit 12. Demosaicing processor 30 performs demosaicing by using an interpolation filter on an original image (RAW image) obtained from an image sensor (not illustrated) and calculates signal values of first colors. Demosaicing processor 30 outputs the calculated signal values of the first colors to computation unit 12.

In the present embodiment, the first colors are red, blue, and clear. Demosaicing processor 30 uses an interpolation filter for the RAW image obtained from the image sensor to calculate a signal value of red, a signal value of blue, and a signal value of clear. More specifically, demosaicing processor 30 targets each of pixels of the image sensor, and calculates signal values of the first colors corresponding to each of the pixels. In the following description, a pixel that is targeted by demosaicing processor 30 among the pixels of the image sensor may be referred to as a target pixel. When signal values of the first colors are calculated for the target pixel, the interpolation filter uses values of pixels that are of an identical color and are adjacent to the target pixel to calculate a signal value of a color different from the color of the target pixel.

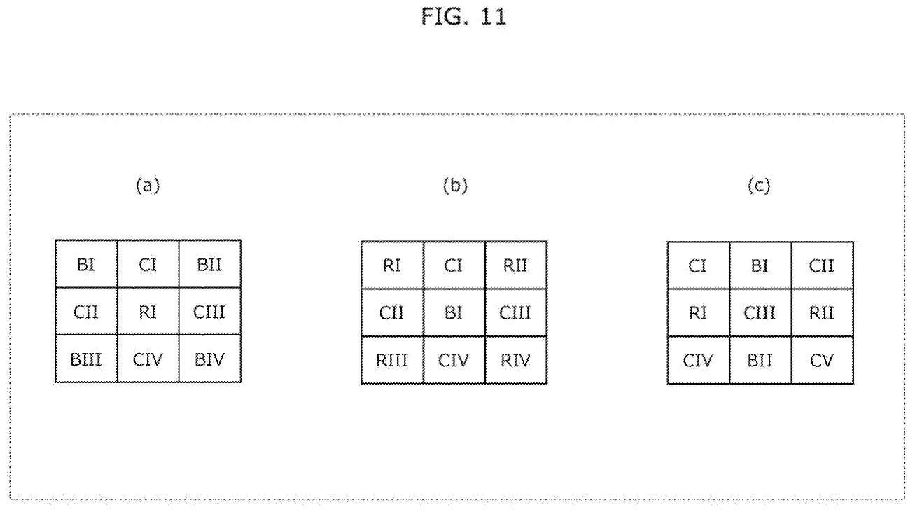

FIG. 11 is a diagram for illustrating an example of the interpolation filter.

In FIG. 11, (a) is a diagram for illustrating when the target pixel is a red pixel. As illustrated in (a) in FIG. 11, a signal value of red output from the target pixel is denoted as RI, signal values of blue output from blue pixels adjacent to the target pixel are denoted as BI, BII, BIII, and BIV, and signal values of clear output from white pixels adjacent to the target pixel are denoted as CI, CII, CIII, and CIV. In this example, among the first colors, demosaicing processor 30 outputs RI as a signal value of red; outputs a mean value of BI, BII, BIII, and BIV output from blue pixels adjacent to the target pixel as a signal value of blue; and outputs a mean value of CI, CII, CIII, and CIV output from white pixels adjacent to the target pixel as a signal value of clear. In other words, demosaicing processor 30 outputs, to computation unit 12, values obtained by the following expressions. R=RI, B=(BI+BII+BIII+BIV)/4, and C=(CI+CII+CIII+CIV)/4.

In FIG. 11, (b) is a diagram for illustrating when the target pixel is a blue pixel. As illustrated in (b) in FIG. 11, a signal value of blue output from the target pixel is denoted as BI, signal values of red output from red pixels adjacent to the target pixel are denoted as RI, RII, RIII, and RIV, and signal values of clear output from white pixels adjacent to the target pixel are denoted as CI, CII, CIII, and CIV. In this example, among the first colors, demosaicing processor 30 outputs BI as a signal value of blue, outputs a mean value of RI, RII, RIII, and RIV output from red pixels adjacent to the target pixel as a signal value of red, and outputs a mean value of CI, CII, CIII, and CIV output from white pixels adjacent to the target pixel as a signal value of clear. In other words, demosaicing processor 30 outputs, to computation unit 12, values obtained by the following expressions. B=BI, R=(RI+RII+RIII+RIV)/4, and C=(CI+CII+CIII+CIV)/4.

In FIG. 11, (c) is a diagram for illustrating when the target pixel is a white pixel. As illustrated in (c) in FIG. 11, a signal value of clear output from the target pixel is denoted as CIII, signal values of red output from red pixels adjacent to the target pixel are denoted as RI and RII, and signal values of blue output from blue pixels adjacent to the target pixel are denoted as BI and BII. In this example, among the first colors, demosaicing processor 30 outputs CIII as a signal value of clear, outputs a mean value of RI and RII output from red pixels adjacent to the target pixel as a signal value of red, and outputs a mean value of BI and BII output from blue pixels adjacent to the target pixel as a signal value of blue. In other words, demosaicing processor 30 outputs values to computation unit 12 obtained by the following expressions. C=CIII, R=(RI+RII)/2, and B=(BI+BII)/2.

Note that demosaicing processor 30 may change the interpolation filter appropriately according to the magnitude of the difference between signal values output from pixels that are of an identical color and adjacent to the target pixel. In other words, demosaicing processor 30 may change the interpolation filter according to the difference between two signal values that are of an identical color and output from two pixels adjacent to a target pixel. For example, when a signal value of a color different from the color of the target pixel is to be calculated among the first colors and the difference between two signal values output from two pixels that are of an identical color and adjacent to the target pixel is less than or equal to a predetermined threshold, a mean value of the two signal values is output. When the difference between the two pixels is greater than the predetermined value, the interpolation filter may be changed to an interpolation filter that outputs a value less than the mean value.

Moreover, an interpolation filter that outputs a value calculated by a weighted mean may be used instead of a mean value. Moreover, the threshold may be set for each color, and may be variable.

Image processing device 10e according to the present embodiment has been described above.

As described above, image processing device 10e according to the present embodiment further includes, upstream of computation unit 12, demosaicing processor 30 that performs demosaicing by using an interpolation filter on a RAW image obtained from the image sensor and calculates the signal values of the plurality of first colors.

This makes it possible to obtain signal values of the first colors, i.e., a signal value of red, a signal value of blue, and a signal value of clear, from a RAW image.

Moreover, demosaicing processor 30 changes the interpolation filter according to a difference between two signal values, the two signal values being of an identical color and output from two pixels adjacent to a target pixel.

This reduces unbalancing of a color for a pixel having a signal value that greatly differs from a signal value of an adjacent pixel. Therefore, this can further suppress coloring in an image that is to be obtained in processing downstream.

### Other Embodiments, Etc.

The image processing device, the image processing method, and the image processing system according to one or more aspects of the present disclosure have been described above on the basis of the embodiments, but the present disclosure is not limited to the embodiments. The one or more aspects may thus include variations achieved by making various modifications to the above embodiments that can be conceived by those skilled in the art, without materially departing from the scope of the present disclosure.

An example in which the first colors are red, blue, and clear has been described in the aforementioned embodiments, but the present disclosure is not limited to this configuration. The first colors may be any two or more colors.

An example in which the second colors are red, blue, and green has been described in the aforementioned embodiments, but the present disclosure is not limited to this configuration. The second colors may be any two or more colors.

In the aforementioned embodiments, an example has been described in which computation unit 12 calculates signal values of the second colors by using three signal values, i.e., a signal value of red, a signal value of blue, and a signal value of clear, but the present disclosure is not limited to this configuration. For example, the computation unit may use three signal values, i.e., a signal value of red, a signal value of green, and a signal value of clear to calculate signal values of the second colors including blue. Alternatively, the computation unit may use three signal values, i.e., a signal value of red, a signal value of clear, and another different signal value of clear to calculate signal values of the second colors. Moreover, the computation unit may use four signal values, i.e., a signal value of red, a signal value of clear, and another signal value of clear, and still another signal value of clear to calculate signal values of the second colors. Moreover, the computation unit may use five or more signal values to calculate signal values of the second colors.

In the aforementioned embodiments, an example has been described in which saturation determiner 14 determines whether or not clear among the first colors is saturated, but the present disclosure is not limited to this configuration. For example, saturation determiner 14 may determine whether or not two colors among the first colors, i.e., clear and red, are saturated. In this example, when two colors among the first colors, clear and red, are determined to be saturated for example, corrector 16 may correct a signal value of red and a signal value of green among the second colors.

Further Information about Technical Background to this Application

The disclosures of the following Japanese Patent Applications including specification, drawings and claims are incorporated herein by reference in its entirety: Japanese Patent Application No. 2020-073508 filed on Apr. 16, 2020 and Japanese Patent Application No. 2021-010664 filed on Jan. 26, 2021.

### INDUSTRIAL APPLICABILITY

The present disclosure is applicable to image capturing devices and the like that capture images.

1. An image processing device, comprising:
a computation unit that calculates signal values of a plurality of second colors by using signal values of a plurality of first colors obtained from an image sensor;
a saturation determiner that determines whether or not at least one of the plurality of first colors is saturated by using the signal values of the plurality of first colors; and
a corrector that corrects at least one signal value of the plurality of second colors and outputs a corrected signal value, when the saturation determiner determines that the at least one of the plurality of first colors is saturated.

2. The image processing device according to claim 1, wherein
the corrector compares a signal value of a color to be corrected among the plurality of second colors with a mean value of signal values of one or more colors that are not to be corrected among the plurality of second colors, and outputs either the signal value of the color to be corrected or the mean value, whichever is greater, as a corrected signal value of the color to be corrected among the plurality of second colors.

3. The image processing device according to claim 1, wherein
the corrector outputs a mean value of signal values of one or more colors that are not to be corrected among the plurality of second colors, as a corrected signal value of a color to be corrected among the plurality of second colors.

4. The image processing device according to claim 2, wherein
the plurality of first colors comprise a color of light that has passed through a filter and has been received by the image sensor, the filter transmitting light in all wavelength regions.

5. The image processing device according to claim 4, wherein
the saturation determiner determines whether or not the color of light that has passed through the filter and has been received by the image sensor is saturated, the color being one of the plurality of first colors.

6. The image processing device according to claim 2, wherein
the corrector corrects a signal value of a color that is one of the plurality of second colors and none of the plurality of first colors.

7. The image processing device according to claim 4, wherein
the plurality of first colors are red, blue, and the color of light that has passed through the filter and has been received by the image sensor,
the plurality of second colors are red, blue, and green, and
among the plurality of second colors, the corrector corrects a signal value of green and calculates the mean value by using a signal value of red and a signal value of blue.

8. The image processing device according to claim 1, further comprising:
a smoothing filter that performs smoothing on a corrected signal value output by the corrector in at least one of a spatial direction or a time direction, when the saturation determiner determines that at least one of the plurality of first colors is saturated.

9. The image processing device according to claim 1, further comprising:
upstream of the computation unit, a demosaicing processor that performs demosaicing by using an interpolation filter on a RAW image obtained from the image sensor and calculates the signal values of the plurality of first colors.

10. The image processing device according to claim 9, wherein
the demosaicing processor changes the interpolation filter according to a difference between two signal values, the two signal values being of an identical color and output from two pixels adjacent to a target pixel.

11. An image processing method, comprising:
calculating signal values of a plurality of second colors by using signal values of a plurality of first colors obtained from an image sensor;
determining whether or not at least one of the plurality of first colors is saturated by using the signal values of the plurality of first colors; and
correcting at least one signal value of the plurality of second colors and outputting a corrected signal value, when the at least one of the plurality of first colors is determined to be saturated.

12. An image processing system, comprising:
a plurality of image processing devices, each being the image processing device according to claim 1, wherein
the plurality of image processing devices process a plurality of exposure images captured at mutually different exposure times and including signal values of the plurality of first colors.
